(19) United States
(12) Patent Application Publication
(10) Pub. No.: US 2002/0062224 A1
(43) Pub. Date: May 23, 2002

(54) HEALTHCARE PAYMENT, REPORTING AND DATA PROCESSING SYSTEM AND METHOD

(76) Inventors: MICHAEL THORSEN, EXCELSIOR, MN (US); MAZHAR SAEED, BROOKLYN PARK, MN (US); JAHAN HAJIANI, MINNEAPOLIS, MN (US)

Correspondence Address: BECK AND TYSVER, 2900 THOMAS AVENUE SOUTH, SUITE 100, MINNEAPOLIS, MN, 55419, US

(21) Appl. No.: 09/316,938

(22) Filed: May 21, 1999

(51) Int. Cl. G06F 17/60

(52) U.S. Cl. 705/2

(57) ABSTRACT

A system and method for managing of healthcare payments to providers on behalf of self-insured employers and their employees and further for generating and managing information flow amongst providers, employers, employees and an administrator. The system is implemented with software operating on general purpose computers.

### FIELD OF THE INVENTION

The present invention relates generally to a system for the payment of healthcare benefits and for generating reports for health care providers, patients and employers about the payment of healthcare benefits. More particularly, the present invention relates to a computer implemented and streamlined system to assist employers who offer their employees health benefits on a employer-insured basis by collecting and maintaining data regarding services provided to patients, paying health care providers who perform these services, collecting payment from employers and patients, and extending credit to the patients for payment of their portion of the fees.

### BACKGROUND OF THE INVENTION

In providing health care benefits to their employees, some employers opt to self-insure. This means that the employer pays for part or all of the health care services that employees receive, in accordance with terms and limitations set by the health plan established by the employer. Typically, such “self-insured” plans are administered by a a “third party administrator” (TPA). It is the TPA's function to adjudicate patient/employee claims in accordance with the terms of the health care plan and to bill the employee/patient for the patient's share of the expense.

Health care providers, including physicians, surgeons, hospitals, physical therapists and the like, typically enter into contracts with health care networks. These contracts provide that in exchange for membership in the network, the provider will provide services at a specified discount. Network membership theoretically is a vehicle for building and maintaining a patient base, thereby reducing the need for providers to market their services on their own.

The typical process for tracking activities and funds in the administration of a health care plan is complex. The following example of current practice will illustrate the process. An employee is employed by a company. The company provides a health plan that provides a particular benefit to the employee if the employee sees providers in a specified network. Assume that the employee visits a doctor in the network for an examination. The doctor sends a bill to the administrator of the network and a statement to the employee/patient. The statement to the patient typically bears an indication that the patient is not to make a payment in response to the statement and that a claim has been submitted to their employer's administrator. The network administrator calculates a discount based on its contractual arrangement with the doctor. The network administrator then sends the repriced bill to the plan administrator for the employer. The plan administrator reviews the services provided, compares this to the benefits provided by the plan and determines what portion, if any the employer is to pay, and which portion the employee is to pay. The plan administrator sends a report to the employer and the employer then makes a payment to the plan administrator. The plan administrator then sends an “explanation of benefits” statement to the employee/patient. The plan administrator sends a check to the doctor and the doctor bills the patient/employee for the remaining amount due. The member then pays the doctor.

This process is rife with inefficiencies, disadvantages and delays. For example, the time period between the patient's visit and the payment to the physician can be very long; it is typically 3-4 months before the physician receives complete payment for his/her services including both the employer's contribution and the employee's.

Further, the time period between the patient's visit to the doctor and receipt of an actual bill is extensive, typically over 2 to 3 months; by which time the patient has forgotten about the services provided and therefore may be unlikely to pay the bill immediately, but rather needs to check their records to satisfy themselves that the bill is accurate and that they have not already paid it. Typically this bill looks similar to the “statement” they received months earlier that they were not supposed to pay. This increases the patient's confusion and can result in further delaying payment to the provider. Consequentially, until the patient receives the final bill, many months after their visit to the doctor, he/she has little idea of how much they will be expected to pay. This makes budgeting difficult and further reduces the odds that the patient will be able to pay the amount due in a timely fashion. In addition, the employee receives separate bills for every episode of health care services. For example, if three members of the employee's family are covered under the health plan and they each visit a doctor for an examination during the course of one month, the employee will receive three separate statements and ultimately three separate bills. This compounds the confusion in an already confusing process, and the greater the confusion the greater the amount that health care providers can lose in unpaid patient bills.

Health bills can be substantial, and employees may not be able to pay large amounts in a lump sum which currently is the only option provided by most health care providers. The employee may take several months to save enough to make the large payment before forwarding it to the doctor, further delaying the doctor's recompense.

In addition, the employer receives separate bills for every incidence of an employee seeking health care. The employer must make payments to the plan administrator that coincide with or are correlated with each specific bill for services from a health care provider.

Health care providers must provide billing information to the network administrator, but also must attend to ultimately billing the patient and collecting the patient's portion of the fee. Collection is a sensitive problem for many providers, because they do not wish to alienate their patients. It is often easier to forego the collection of the patient's portion which is typically significantly smaller than the employer's portion, for the sake of a continuing relationship with the patient through which the health care provider can receive the lion's share of the payment from the employer.

Each claims follows a serial path, often with delays at every step in the path.

Health care costs are inflated to account for these and other inefficiencies and disadvantages in this current system. What is needed is a system and method by which claims are processed in a streamlined fashion and in which various aspects of the claim processing process occur in parallel. What is further needed is a system and method by which providers are paid promptly; clear and simple bills are provided to patients; employers are relieved of the burden of tracking individual health care incidences; payment is made easier and therefore more likely for patients by the extension of credit; and, in general, reducing the number of communications of all types associated with each health care transaction and to lower barriers to fast and complete payment of health care bills.

### SUMMARY OF THE INVENTION

A method and system of administering health care benefits according to the present invention makes a single entity the focal point for all transactions associated with the administration of health care benefits. For purposes of this description, this entity will be called the “benefits administrator” or “administrator”. Under the system of the present invention, the administrator performs a variety of functions to streamline the process of processing payments and handling information stemming from the provision of health care services in the context of self-insured plans funded primarily by employers for their employees.

According to a preferred embodiment of the present invention, an employee has health benefits through a “self-insured” employer. The plan covers the employee and their family members. A patient visits a network health care provider. The patient might be the employee him/herself or any covered family member, but will hereafter be identified as the “employee.” The employee displays a card to the health care provider that identifies the employee and the administrator. The health care provider examines, treats or otherwise provides service to the employee. The provider then sends a claim form for those services to the administrator. The health care provider does not send a statement or bill to the employee or to the employee's employer.

The administrator reports to the employer on a regular basis, preferably weekly, with an aggregate amount for services rendered under the employer's health plan. The employer pays the aggregate amount to the administrator. While detailed reports of services rendered to employees is available to the employer, the employer is not burdened with individual statements or reports each time a service is rendered.

The administrator aggregates all paid claims in a given month by employee and their family members covered by their plan into a consolidated statement. The administrator sends the employee a monthly statement of which the first page resembles a credit card bill, listing all services paid for the family for the time period. The second and subsequent pages sorts the services received by family member and describes the services provided in plain English rather than in the alpha-numeric codes typically used in the processing of health care benefits. The report also includes year-to-date summaries of health care services, including employer payments, employee deductibles, coinsurance and out-of-pocket amounts, for each family member. The employee pays the bill by the specified due date in whole or, at the employee's option, in installments with interest. In other words, the employee's health care benefits are billed and collected by the administrator in a manner analogous to the way credit card companies bill and collect. Credit card companies aggregate bills from all businesses where the credit card is used during a specified period; they collect partial or full payment from the card holder, charge interest for partial payment and pay funds to the businesses where the card holder made purchases.

The administrator aggregates all adjudicated claims for the provider over a period of time and promptly pays the health care provider the aggregate amount regardless of whether the health care provider has received payment from the employee. In this way, the administrator passes along the employer's contributions for the claims in the time period and “floats” the employees' portions of the claims. The health care provider does not, at any time, bill the employee nor does the provider attend to collecting from the patients.

A number of contractual relationships undergird the system. An administrator enters into a contractual relationship with an employer to provide administrative services in exchange for a service fee. Health care providers enter into contracts to be members of networks in exchange for providing services at a discounted rate. Benefit administrators contract with networks to receive their negotiated discounts to pass on to the employers' benefit plans for which they administer health care claims. Employers and employees have a pseudo-contractual arrangement whereby the employer provides salary and health care benefits to the employee in exchange for the employee's time and labor.

### BRIEF DESCRIPTION OF THE DRAWINGS

An exemplary version of a system and method for administering health benefits is shown in the figures wherein like reference numerals refer to equivalent structure throughout, and wherein:

FIG. 1 is a schematic representation of a preferred system and method according to the present invention;

FIG. 2 is a more detailed schematic representation of the system and method of FIG. 1;

FIGS. 3a and 3b are a flow chart illustrating the system and method of FIGS. 1 and 2;

FIGS. 4a and 4b are a depiction of the claim forms submitted by a health care provider to an administrator according to the present invention;

FIG. 5 is a depiction of a report (Explanation of Payment) provided by an administrator to a health care provider according to the present invention;

FIG. 6 is a depiction of a report (“Funding Request”)provided to an employer in accordance with the system and method of the present invention;

FIGS. 7a and 7b are a depiction of a report (“Consolidated Statement”) provided to a covered employee in accordance with the system and method of the present invention; and

FIG. 8 is a depiction of hardware and software used according to a preferred embodiment of the present invention.

### DETAILED DESCRIPTION OF PREFERRED EMBODIMENT(S)

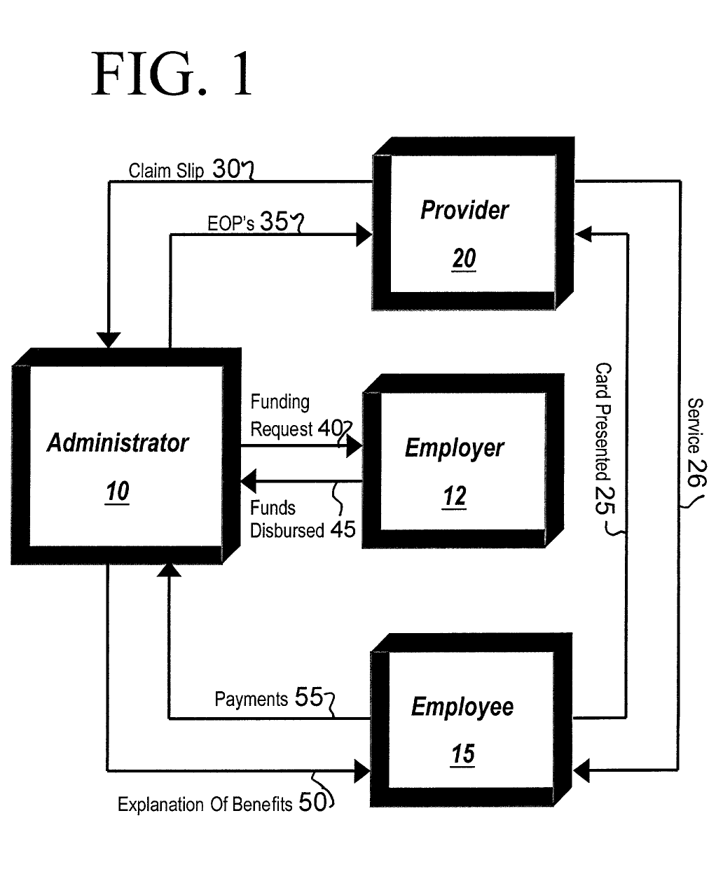

A preferred method and system of administering health care benefits is illustrated conceptually in FIG. 1. Under the system of the present invention, an administrator 10 performs a variety of functions to streamline the process of processing payments and handling information stemming from the provision of health care services in the context of self-insured plans funded primarily by employers for their employees.

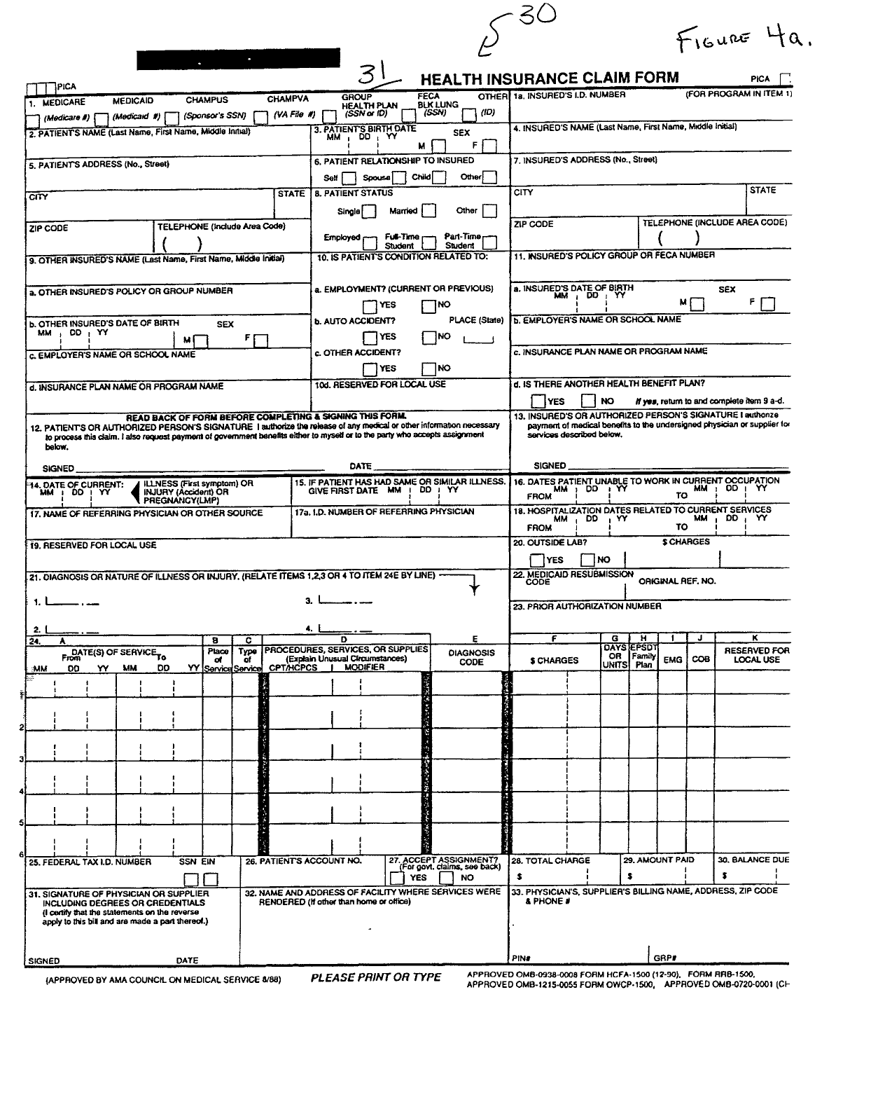

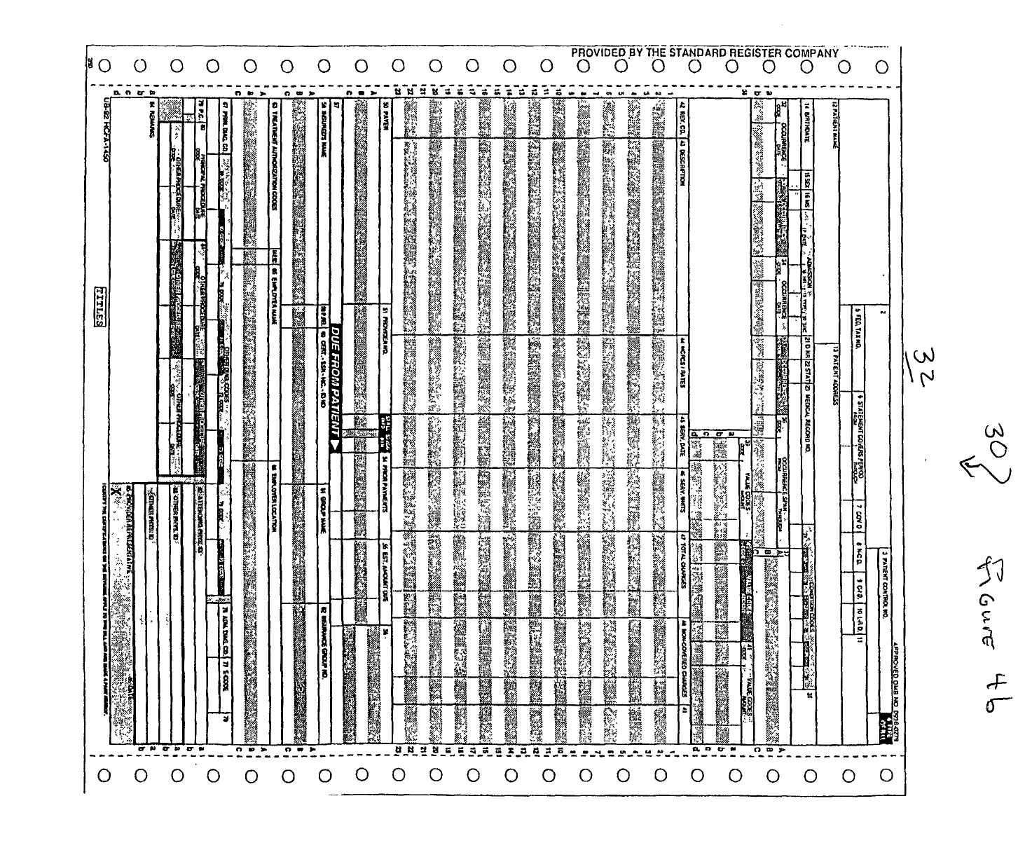

An employer 12 provides a health care plan to its employees and their family members. A employee 12 covered by an employer's health plan visits a health care provider 20. According to the system and method of the present invention, the employee 15 displays a card 25 to the health care provider 20 that identifies the employee 15 and the administrator 10. The health care provider 20 examines, treats or otherwise provides service 26 to the employee 15. The provider 20 then sends a charge or claim form 30 for those services to the administrator 10. An example of a claim form 30 is illustrated in FIGS. 4a and 4b. The form 31 illustrated in FIG. 4a shows FORM RRB-1500, a standard form used in the industry. The form 32 illustrated in FIG. 4b is Form UB-92 HCFA-1450, another standard form used in the industry. The health care provider 20 does not send a statement or bill to the employee or to the employee's employer.

The preferred system and method includes a primary funding process for receiving funds from the employer and depositing funds in an aggregate fund. The administrator 10 reports 40 to the employer 12 on a regular basis, preferably weekly, with an aggregate amount for the services rendered under the employer's health plan. The employer 12 then pays 45 the aggregate amount to the administrator 10. While detailed reports of services rendered to each employee 15 is available to the employer 12, the employer 12 is not burdened with individual statements of reports each time a service is rendered.

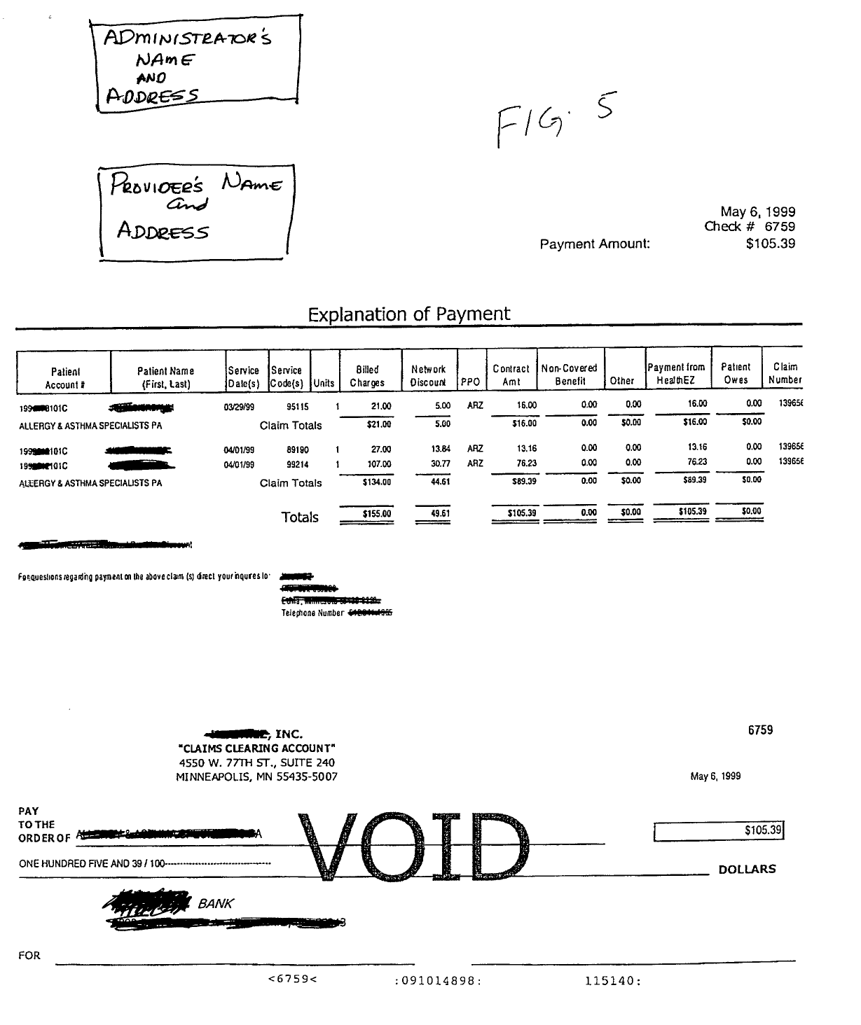

The preferred system includes a payment process for paying provider claims for services delivered to an employee from an aggregate fund. The administrator 10 aggregates all claims from the provider 20 for all employees covered by plans administered by the administrator 10 over a period of time and promptly pays 35 the health care provider 20 the aggregate amount received from employers, preferably within 2 weeks. This payment is preferably made promptly even though a portion of the claim to be paid by the employee 15 has not yet been collected. The administrator 10 gives the provider 20 a report, such as the “explanation of payment” report 21 illustrated in FIG. 5, that lists all claims for a period. The report 21 identifies each claim by claim number for the provider's convenience in recording payment in his/her own accounting system. The report 21 further lists the amount being paid by the administrator 10 and the amount owed by the employee 15. One convenient manner for making the payment to the provider is to have a check 22 as an integral, perforated part of the explanation of payment 35.

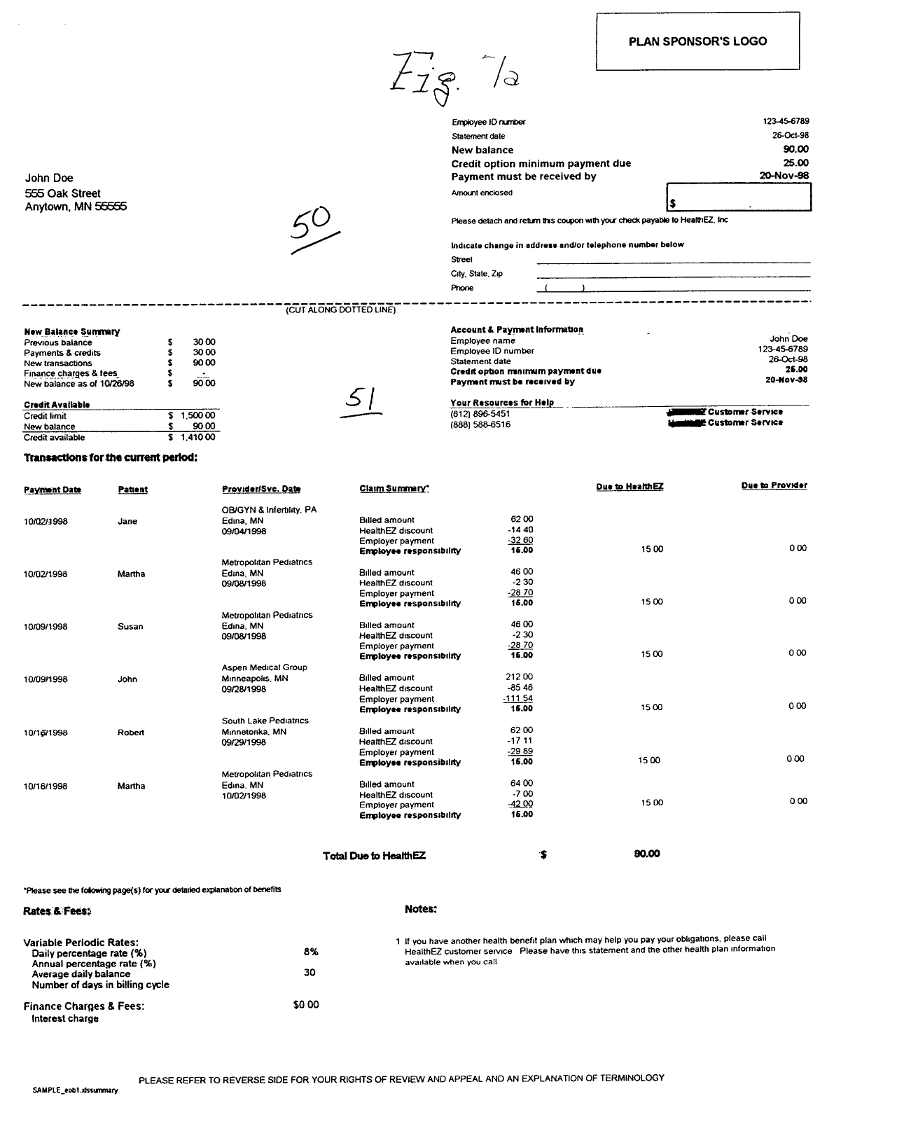

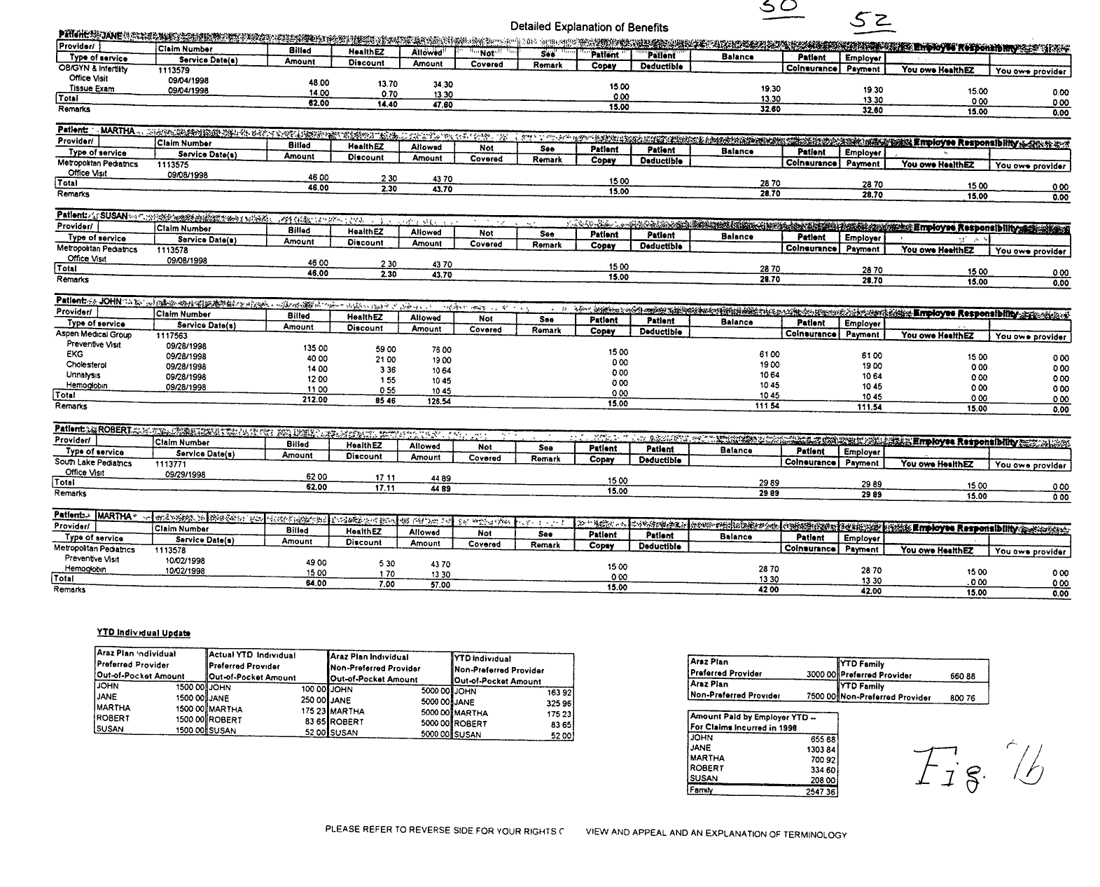

The preferred system and method include a secondary funding process for receiving employee contribution funds. With reference to FIG. 1, the administrator 10 aggregates all bills for health care provided to an employee 15 and his/her family members covered by their plan for a period, preferably one month. The administrator 10 sends the employee 15 a monthly bill 50 that resembles a credit card bill, listing all services provided for the family for the time period. An exemplary monthly bill 50 is illustrated in FIGS. 7a and 7b. The bill includes a consolidated statement 51 shown in FIG. 7a and a Detailed Explanation of Benefits 52 shown in FIG. 7b. Preferably the consolidated statement 51 includes year-to-date summaries of health care services provided for the family for the year. The Detailed Explanation of Benefits 52 lists all services provided for family members during the billing period. Preferably, the report sorts the services provided by family member. The description of services provided is in plain English rather than in the alpha-numeric codes typically used in the processing of health care benefits. The report shows the amount paid by the employer for each claim and summarizes the employers payments for the billing period and year. As described below, employees may receive both portions 51 and 52 of the bill or just the Detailed Explanation of Benefits 52 depending on their participation in the credit option offered by the administrator.

In the preferred system and method, a tertiary funding process acquires funds from a credit source to complete the employee's contribution. As diagrammed in FIG. 1, the employee 15 pays 55 the bill 50 by the specified due date in whole or, at the employee's option, in installments with interest.

The primary funding process, the secondary funding process, and the tertiary funding process are coupled to the payment process. The secondary funding process and tertiary funding process occur “in parallel with” the payment process. In other words, the administrator 10 pays the provider 20 regardless of whether the administrator 10 has collected the employee's contribution from the employee 15.

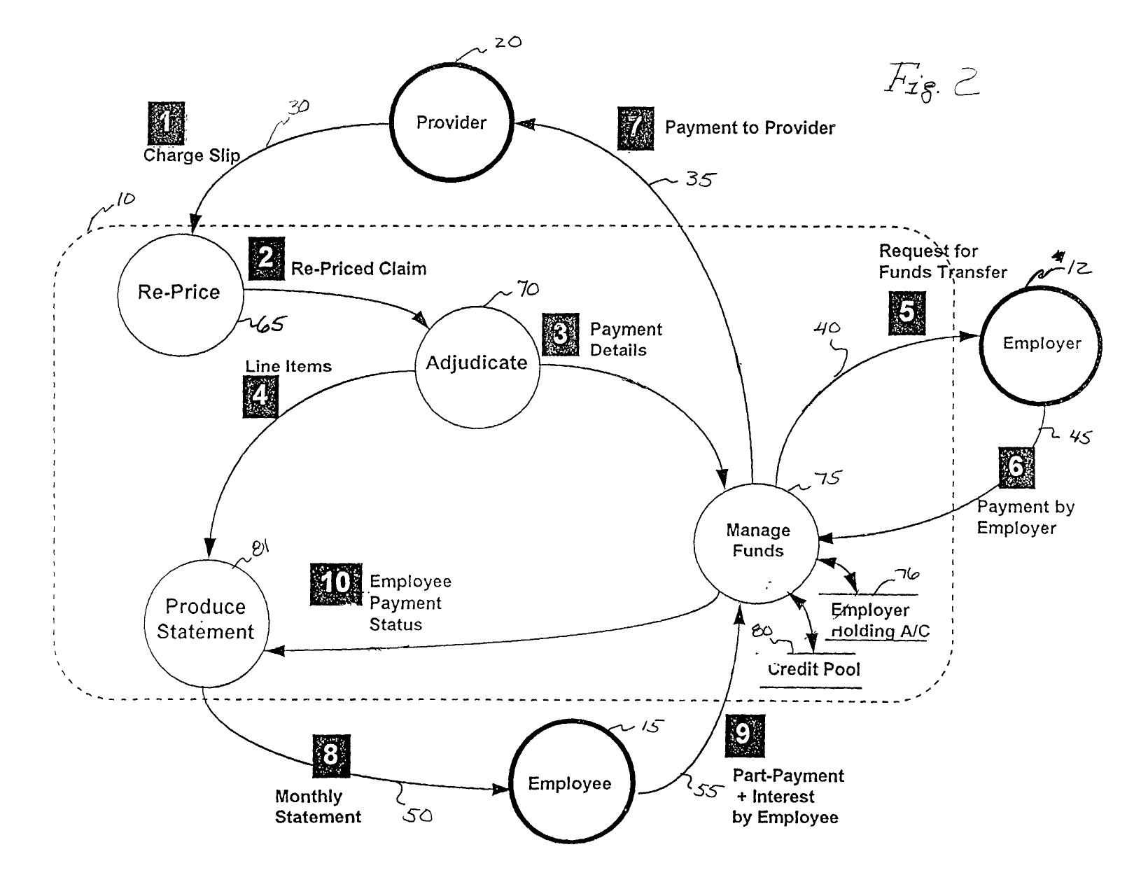

FIG. 1 schematically illustrates the flow of information and funds between and amongst the administrator, the provider, the employer and the employee. This is also illustrated in FIG. 2. FIG. 2 further illustrates internal functions performed by the administrator in a preferred system and method. In addition to the functions discussed above, the administrator 10 performs several auxiliary functions. When a charge slip or claim form 30 is sent by the provider 20 to the administrator 10, the administrator compares the charges to the discounted charges set forth by contract between the provider and the administrator, directly or indirectly through a network. The administrator then re-prices 65 the claim to conform with previously agreed-upon prices for each service rendered.

The re-priced claim is then “adjudicated” 70. Adjudication involves determining how much an employer and an employee each must pay for the service rendered. This involves a comparison of the service provider to the list of preferred providers as specified by the health plan to determine whether the service provider is “in-network” or not. Adjudication further involves comparing the services rendered with the employer's health plan to determine whether a claim is covered and to what extent and how liability is apportioned between employer and employee.

The administrator 10 manages funds 75 received from the employer and from the employee. Funds received from employers are placed in an account 76 and held until forwarded to the appropriate providers. Additionally, the administrator 10 maintains a credit pool 80 from which the administrator 10 pays the employees' portions to providers.

The funds management function 75 further includes maintaining and organizing data regarding amounts received from an employee and the amounts contributed by employers and using this information to generate or produce 81 statements 50 set to the employee 15.

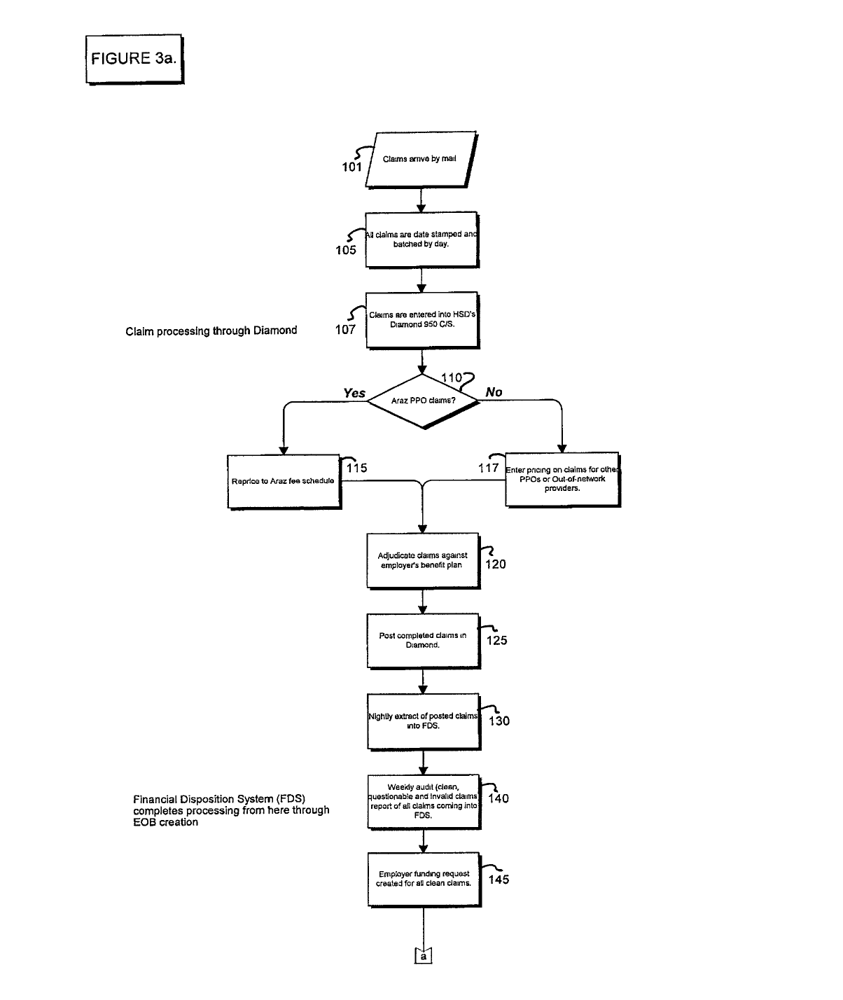

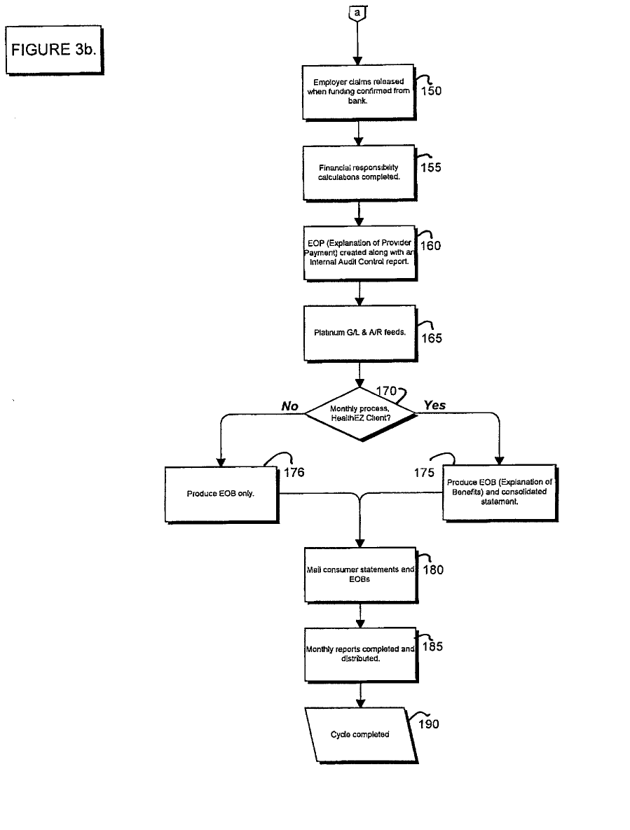

FIGS. 3a and 3b present a preferred system and method according to the present invention in flow-chart format and in greater detail. Generally, this diagram illustrates the process a single claim follows as it flows through the system, although some of the steps involve the aggregation of more than one claim. The diagram represents the administrator's role in the process. A claim on a claim slip is mailed or otherwise sent by a provider and is received 101 by the administrator. The claim is date stamped and all claims received on a given day are batched by day 102. Each claim is “entered” into a database for processing using the Health Systems Design Diamond software that runs on a computer 107. Entry may be made by typing by hand or by scanning methods. Next, a determination is made as to whether the claim has come from a network provider 110. If so, the amount of the claim is discounted or re-priced 115 according to contractual agreement direct or indirect between the administrator and the provider. If not, the price on the claim is recorded 117 as is.

Next, the software “adjudicates” the claim 120. This step involves a comparison of the services rendered to the services covered by the employee's health plan. This step further involves the assessment of the portion of the claim that is to be paid by the employer and the portion to be paid by the employee. The completed claims are then “posted” 125 by the Diamond software. The posted data is in a format that can be retrieved by the financial disposition system.

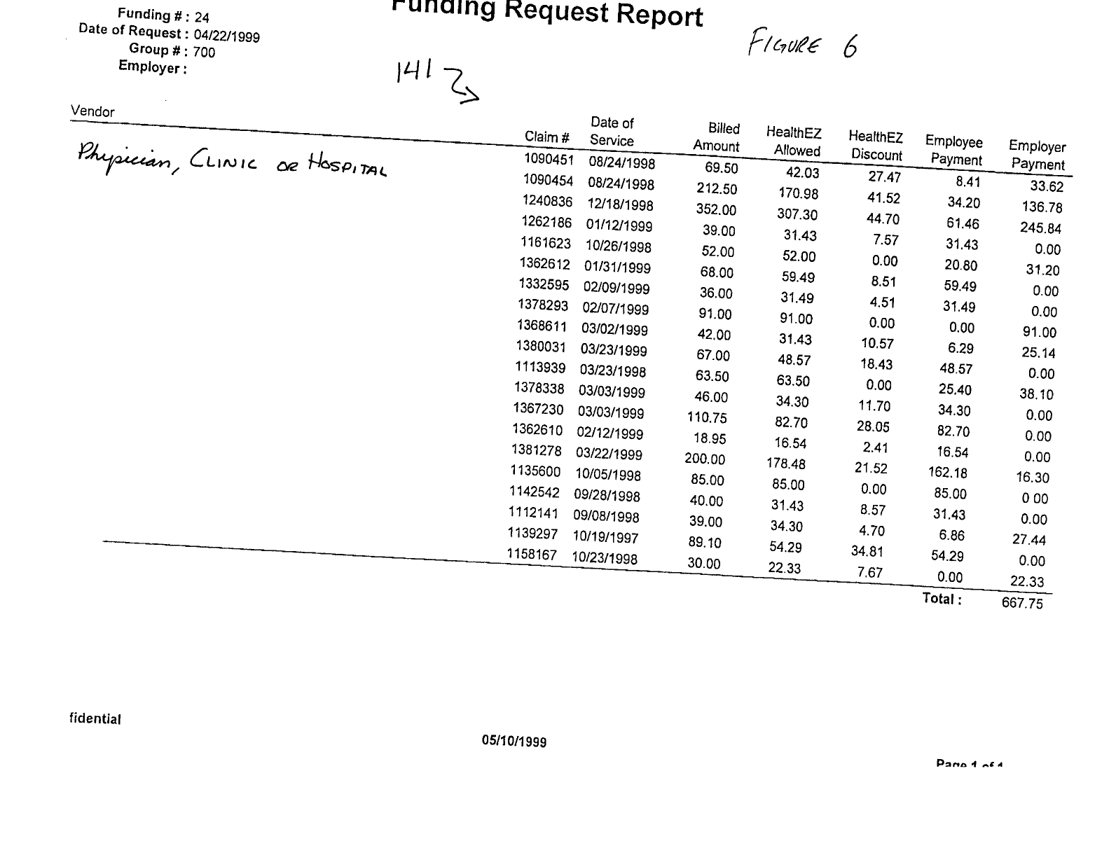

Nightly, the financial disposition system extracts the posted claims from Diamond 130. The financial disposition system audits the claims and generates a report setting forth which claims are “invalid” e.g. for a procedure not covered, which are “questionable” and require further investigation by a person, and which are “clean” in proper order for continued automatic processing 140. The financial disposition system then generates a funding request 141, illustrated in FIG. 6, for aggregated clean claims for each employer 145.

The employer will forward payment of the requested amount within an agreed upon period that is preferably quite short, such as one week. Preferably, the employer transfers money by wire or by other electronic method. When payment is received, or when its receipt is confirmed by the bank, it is recorded in the financial disposition system and claims against the employer are released 150.

The financial disposition software then performs financial responsibility calculations 155. This calculation identifies the amount that the administrator needs to advance for each employee.

Next, the financial disposition software generates the “explanation of payment” and forwards this to the provider with the administrators payment 160. The payment consists of the employers' portions of claims. In addition, the financial disposition software generates an internal audit report that shows all the components, discounts, employer's portion and employee's portion, for each claim.

The financial disposition system then passes data to The Platinum General Ledger and Accounts Receivable software 165 to record the appropriate accounting entries and audit trail.

The financial disposition system periodically, preferably monthly, processes data to bill the employee. The system determines whether claims are for credit or non-credit client of the administrator 170. If it is a credit client, the system generates an “explanation of benefits”, FIG. 7b, and a consolidated statement, FIG. 7a, as indicated at reference number 175. If a non-credit client, the system generates only an explanation of benefits, FIG. 7b only, at reference number 176. The explanation of benefits and statements are then mailed to employees 180 periodically, preferably monthly. Because the statements are issued periodic rather than episodic, the employee sees the report regularly, is familiar with its format and can expect it in the mail. This regularity increases the likelihood that the employee will promptly pay the amount due.

Finally, monthly reports, summarizing the employer's claim payment activity, are completed and distributed 185 and the process is completed 190.

Preferably, the system and method of the present invention are automated through the use of one or more computers running software and storing and processing data in one or more databases. The computer and/or its storage media or medium are linked to one or more printers to print the various reports, statements and checks that are produced by this system and method.

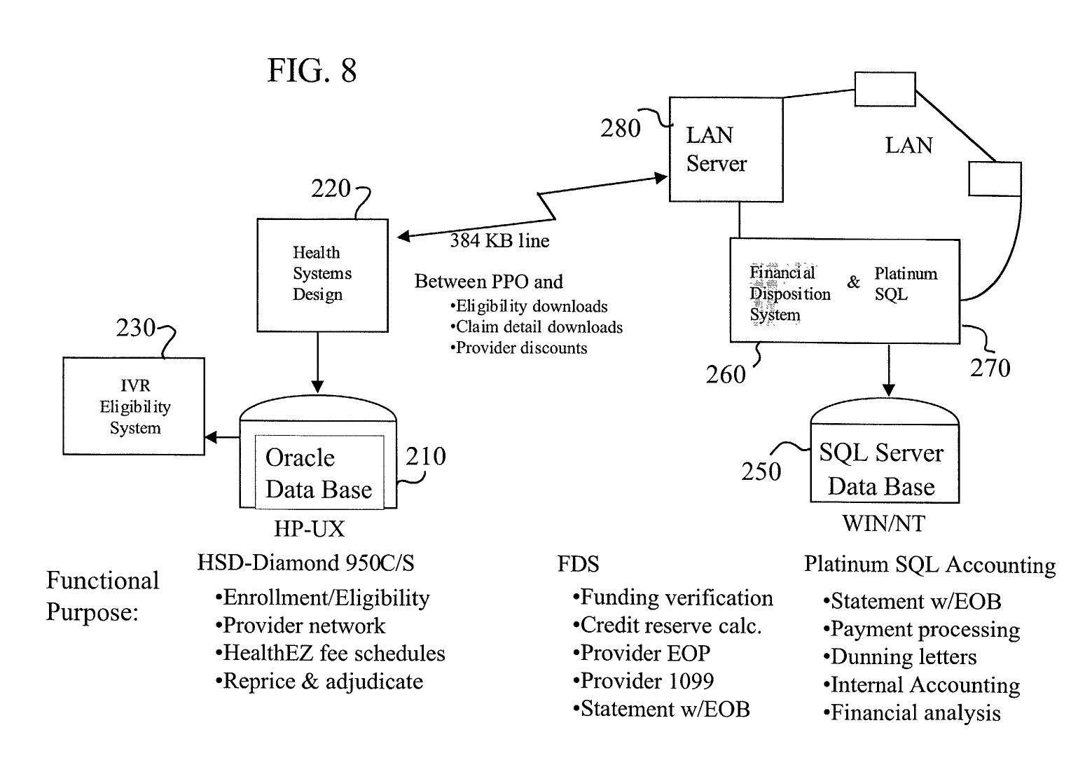

Hardware and software for use in conjunction with the system and method of the present invention are depicted in FIG. 8. An Oracle database 210, in conjunction with a Health Systems Design HSD software 220 and an IVR Eligibility System 230, performs the functions of enrolling new members, confirming eligibility, managing the provider network, storing fee schedules and re-pricing and adjudicating claims for providers services. An SQL server data base 250 in conjunction with a financial disposition system 260 performs the functions of verifying funding, calculating the credit reserve, preparing the “explanation of payment” for employers, preparing 1099 tax forms for providers, and preparing “consolidated statements” and “explanation of benefit” statements for employees. Off-the-shelf Platinum SQL Accounting software 270 is linked to and coordinated with the SQL Server data base 250 and the financial disposition system 260 to process payments, prepare Dunning letters, perform internal accounting functions and conduct financial analysis. Additionally, the Platinum SQL 270 assists with the preparation of the “explanation of benefits” statement for employees. The financial disposition system 260 and the Platinum SQL Accounting package 270 are integrated through a local area network LAN 280. Similarly, the financial disposition system 260 and the Platinum SQL Accounting package 270 are accessible through the LAN 280. With reference to FIGS. 3a and 3b, the Diamond software 220 performs functions 107-130. The financial disposition system 260 performs functions 140-190.

Efficiencies are achieved if a single entity performs the functions of: receiving and re-pricing providers claims; adjudicating claims; collecting funds from employers; paying the provider; giving the provider an explanation of payment; billing employees; and collecting employee payments. Nevertheless, select functions or groups of functions can be performed by separate entities within the spirit of this invention.

Although an illustrative version of the system and method is shown and described, it should be clear that many modifications to the system and method may be made without departing from the scope of the invention.

What is claimed is:

1. A computerized system for tracking healthcare services, making payment to providers for services, and collecting payment from employers and employees for such services, comprising:
a) a payment process for paying provider claims for services delivered to an employee from an aggregate fund;
b) a primary funding process coupled to said payment process for replenishing funds disbursed by said payment process, by receiving funds from the employee's employer and depositing said funds in said aggregate fund;
c) a secondary funding process coupled to said payment process for receiving employee contribution funds said funds payable to said aggregate fund; and
d) a tertiary funding process coupled to said payment process for acquiring funds from a credit source to complete employee contribution funds.

2. A method for tracking healthcare services, making payment to providers for services, and collecting payment from employers and employees for such services, comprising:
a) executing a payment process for paying provider claims for services delivered to an employee from an aggregate fund;
b) executing a primary funding process coupled to said payment process for replenishing funds disbursed by said payment process, by receiving funds from the employee's employer and depositing said funds in said aggregate fund;
c) executing a secondary funding process coupled to said payment process for receiving employee contribution funds said funds payable to said aggregate fund;
d) executing a tertiary funding process coupled to said payment process for acquiring funds from a credit source to complete employee contribution funds.

3. A method of health benefit payment and reporting, comprising the steps of:
a) provider reporting to a first entity the provision of services to a patient;
b.) said entity reporting to employer on a periodic basis the aggregate amount owed by employer for services rendered for the employer's employees during the period;
c.) said entity reporting to patient on a periodic basis the amount owed by patient for provider services rendered;
d.) collecting payment from the employer;
e.) said entity paying said provider for services within a predetermined time period after the provisions of services;, regardless of whether the entity has received payment from said patient; and
f.) collecting payment from the patient.

4. A method of benefit payment and reporting according to claim 3, wherein said entity extends credit to said patient, such that said patient can pay the provider bills in installments, said installments being paid to said entity.

5. A method of benefit payment and reporting according to claim 4, wherein said entity calculates the risk associated with extending credit to patients, and incorporates the risk into the pricing of its services to employers and physicians.

6. A data processing system for managing the reporting of services provided and the payment and collection associated with the provision of healthcare services by a healthcare provider to an employee of an employer who provides a health plan for employees, comprising:
a.) computer processor means for processing data;
b.) storage means for storing data on a storage medium;
c.) first means for processing data regarding services provided by a healthcare provider to a patient;
d.) second means for processing data regarding employers, their employees and the aggregate of services provided for a particular employer's employees by healthcare providers during a predetermined time period;
e.) third means for processing data regarding all services rendered during a predetermined time period for each employee, including all people covered under employee's health plan.

7. A data processing system according to claim 6, further comprising;
f.) fourth means for generating a report to employer stating the amount owed for the aggregate of all services provided to employees during a predetermined time period;
g.) fifth means for generating a report to employees identifying all services provided by all health care providers for all people covered by the health plan for each employee, and stating an amount owed by employee.

8. A data processing system according to claim 6, further comprising:
f.) fourth means for making payment to a healthcare provider for services rendered for an employer's employee within two weeks of the provision of services;
g.) fifth means for processing data regarding amounts owed to and paid to provider.
